(19) United States
(12) Patent Application Publication
(10) Pub. No.: US 2004/0093591 A1
(43) Pub. Date: May 13, 2004

(54) Method and apparatus prefetching indexed array references

(76) Inventors: Spiros Kalogeropulos, Los Gatos, CA (US); Partha P. Tirumalai, Fremont, CA (US); Mahadevan Rajagopalan, Fremont, CA (US); Yonghong Song, Sunnyvale, CA (US); Subbarao Vikram Rao, Sunnyvale, CA (US)

Correspondence Address: PARK, VAUGHAN & FLEMING LLP, 508 SECOND STREET, SUITE 201, DAVIS, CA, 95616, US

(21) Appl. No.: 10/412,154

(22) Filed: Apr. 10, 2003

Related U.S. Application Data
(60) Provisional application No. 60/425,692, filed on Nov. 12, 2002.

(51) Int. Cl. G06F 9/45

(52) U.S. Cl. 717/155; 717/141; 717/161

(57) ABSTRACT

One embodiment of the present invention provides a system that generates prefetch instructions for indexed array references. Upon receiving code to be executed on a computer system, the system analyzes the code to identify candidate references to be prefetched, wherein the candidate references can include indexed array references that access a data array through an array of indices. Next, the system inserts prefetch instructions into the code in advance of the identified candidate references. If the identified candidate references include indexed array references, this insertion process involves, inserting an index prefetch instruction into the code, which prefetches a block of indices from the array of indices. It also involves inserting data prefetch instructions into the code, which prefetch data items in the data array pointed to by the block of indices.

### RELATED APPLICATION

This application hereby claims priority under 35 U.S.C. §119 to U.S. Provisional Patent Application No. 60/425,692, filed on 12 Nov. 2002, entitled “An Algorithm for Anticipatory Prefetching in Loops,” by inventors Spiros Kalogeropulos, Partha P. Tirumalai, Mahadevan Rajagopalan, Yonghong Song and Vikram Rao (Attorney Docket No. SUN-P8799PSP).

### BACKGROUND

1. Field of the Invention

The present invention relates to compilers for computer systems. More specifically, the present invention relates to a method and an apparatus for generating prefetch instructions for indexed array references within an optimizing compiler.

2. Related Art

Advances in semiconductor fabrication technology have given rise to dramatic increases in microprocessor clock speeds. This increase in microprocessor clock speeds has not been matched by a corresponding increase in memory access speeds. Hence, the disparity between microprocessor clock speeds and memory access speeds continues to grow, which can cause performance problems. Execution profiles for fast microprocessor systems show that a large fraction of execution time is spent not within the microprocessor core, but within memory structures outside of the microprocessor core. This means that the microprocessor systems spend a large fraction of time waiting for memory references to complete instead of performing computational operations.

In order to remedy this problem, some microprocessors provide hardware structures to facilitate prefetching of data and/or instructions from memory in advance of wherein the instructions and/or data are needed. Unfortunately, because of implementation constraints, these hardware prefetching structures have limited sophistication, and are only able to examine a limited set of instructions to determine which references to prefetch. As more processor clock cycles are required to perform memory accesses, prefetch operations must take place farther in advance of where the prefetched data is needed. This makes it harder for hardware prefetching mechanisms to accurately determine what references to prefetch and when to prefetch them.

A number of compiler-based techniques have been developed to insert explicit prefetch instructions into executable code in advance of where the prefetched data items are required. Such prefetching techniques can be effective in generating prefetches for data access patterns having a regular “stride”, which allows subsequent data accesses to be accurately predicted.

However, existing compiler-based techniques are not effective in generating prefetches for irregular data access patterns, which commonly occur, for example, when using an array of indices to access items in a data array. Note that the cache behavior of these indexed array references cannot be predicted at compile-time.

Hence, what is needed is a method and an apparatus that facilitates performing prefetch operations for irregular data access patterns.

### SUMMARY

One embodiment of the present invention provides a system that generates prefetch instructions for indexed array references. Upon receiving code to be executed on a computer system, the system analyzes the code to identify candidate references to be prefetched, wherein the candidate references can include indexed array references that access a data array through an array of indices. Next, the system inserts prefetch instructions into the code in advance of the identified candidate references. If the identified candidate references include indexed array references, this insertion process involves, inserting an index prefetch instruction into the code, which prefetches a block of indices from the array of indices. It also involves inserting data prefetch instructions into the code, which prefetch data items in the data array pointed to by the block of indices.

In a variation on this embodiment, the index prefetch instruction is inserted sufficiently in advance of the data prefetch instructions, so that the block of indices can be prefetched before the data prefetch instructions are executed. Furthermore, the data prefetch instructions are inserted sufficiently in advance of instructions that use the data items, so that the data items can be prefetched before the data items are used.

In a variation on this embodiment, inserting the index prefetch instruction into the code involves obtaining a stride value for the array of indices. It also involves calculating a prefetch ahead distance as a function of a covered latency and a prefetch queue utilization. The covered latency is calculated by dividing a latency for a prefetch operation by an execution time for a single loop iteration. The prefetch queue utilization is calculated by dividing a maximum number of outstanding prefetch operations for the computer system by a number of prefetch instructions emitted within a loop body. Finally, the system calculates a prefetch ahead value for the index prefetch instruction by multiplying the stride value by the prefetch ahead distance.

In a variation on this embodiment, the prefetch instructions are associated with non-faulting load operations that do not raise an exception for an invalid address.

In a variation on this embodiment, analyzing the code to identify candidate references to be prefetched involves identifying loop bodies within the code, and identifying candidate references to be prefetched from within the loop bodies.

In a further variation, analyzing the code to identify candidate references to be prefetched involves examining a pattern of data references over multiple loop iterations.

In a variation on this embodiment, indexed array references are identified as candidate references only if an associated array of indices is not modified within a loop body.

In a variation on this embodiment, inserting prefetch instructions into the code involves: inserting irregular prefetch instructions into the code, including prefetch instructions associated with indexed array references; inserting regular prefetch instructions into the code, including prefetch instructions inserted into modulo scheduled loops; and inserting prefetch instructions for remaining candidate references into the code.

In a variation on this embodiment, analyzing the code to identify candidate references to be prefetched involves performing reuse analysis on the code to determine which array references are likely to generate cache misses.

In a variation on this embodiment, analyzing the code involves analyzing the code within a compiler.

### BRIEF DESCRIPTION OF THE FIGURES

FIG. 1 illustrates a computer system in accordance with an embodiment of the present invention.

FIG. 2 illustrates a compiler in accordance with an embodiment of the present invention.

FIG. 3 is a flow chart illustrating the process of inserting prefetch instructions into code in accordance with an embodiment of the present invention.

FIG. 4 is a flow chart illustrating the process of performing two-phase marking to identify references for prefetching in accordance with an embodiment of the present invention.

FIG. 5 illustrates how a data array is accessed through an array of indices in accordance with an embodiment of the present invention.

FIG. 6 illustrates how prefetches are inserted in accordance with an embodiment of the present invention.

FIG. 7 presents a flow chart illustrating the process of determining which instructions belong to a candidate set for prefetching in accordance with an embodiment of the present invention.

FIG. 8 presents a flow chart illustrating how prefetches are inserted for indexed array references in accordance with an embodiment of the present invention.

Table 1 illustrates marking of an exemplary section of code in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

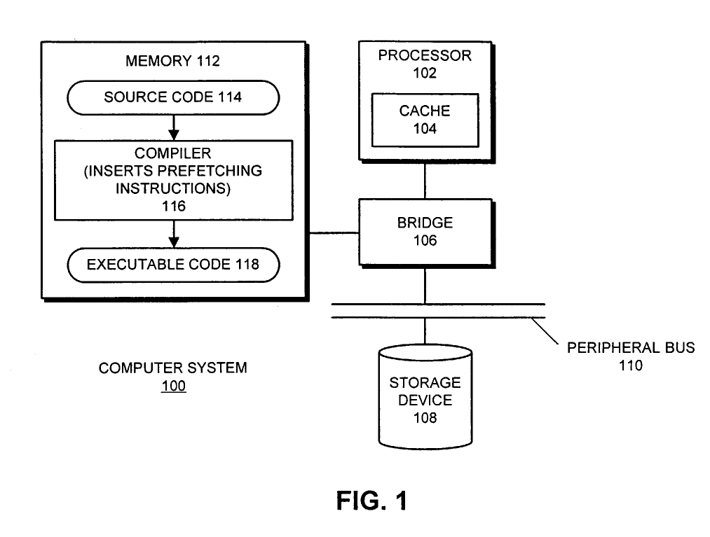

FIG. 1 illustrates a computer system 100 in accordance with an embodiment of the present invention. As illustrated in FIG. 1, computer system 100 includes processor 102, which is coupled to a memory 112 and to peripheral bus 110 through bridge 106. Bridge 106 can generally include any type of circuitry for coupling components of computer system 100 together.

Processor 102 can include any type of processor, including, but not limited to, a microprocessor, a mainframe computer, a digital signal processor, a personal organizer, a device controller and a computational engine within an appliance. Processor 102 includes a cache 104 that stores code and data for execution by processor 102.

Note that the effect of a prefetch operation is to cause a cache line to be retrieved from memory 112 into cache 104 before processor 102 accesses the cache line. Note that many computer systems employ both a level-two (L2) cache as well as a level-one (L1) cache. In this type of computer system, a prefetch operation can cause a cache line to be pulled into L2 cache as well as L1 cache. Note that all of the following discussion relating to prefetching an L1 cache line applies to prefetching an L2 cache line. Furthermore, note that the present invention can also be applied to computer systems with more than two levels of caches.

Processor 102 communicates with storage device 108 through bridge 106 and peripheral bus 110. Storage device 108 can include any type of non-volatile storage device that can be coupled to a computer system. This includes, but is not limited to, magnetic, optical, and magneto-optical storage devices, as well as storage devices based on flash memory and/or battery-backed up memory.

Processor 102 communicates with memory 112 through bridge 106. Memory 112 can include any type of memory that can store code and data for execution by processor 102.

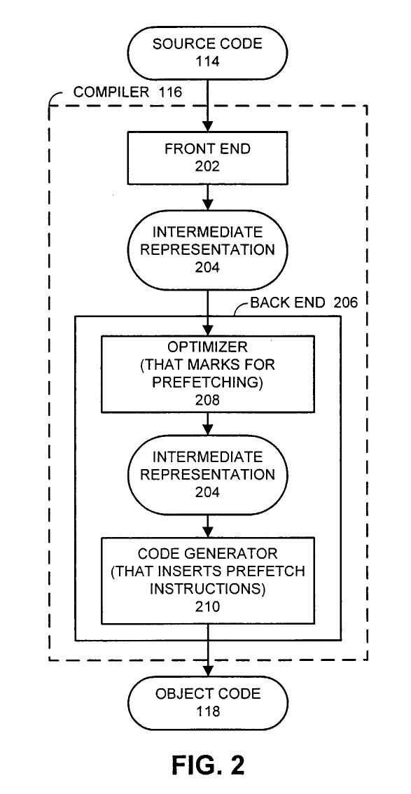

As illustrated in FIG. 1, memory 112 contains compiler 116. Compiler 116 converts source code 114 into executable code 118. In doing so, compiler 116 inserts explicit prefetch instructions into executable code 118 as is described in more detail below with reference to FIGS. 2-8.

Note that although the present invention is described in the context of computer system 100 illustrated in FIG. 1, the present invention can generally operate on any type of computing device that can accommodate explicit prefetch instructions. Hence, the present invention is not limited to the specific computer system 100 illustrated in FIG. 1.

Compiler

FIG. 2 illustrates the structure of compiler 116 in accordance with an embodiment of the present invention. Compiler 116 takes as input source code 114 and outputs executable code 118. Note that source code 114 may include any computer program written in a high-level programming language, such as the JAVA™ programming language. Executable code 118 includes executable instructions for a specific virtual machine or a specific processor architecture.

Compiler 116 includes a number of components, including as front end 202 and back end 206. Front end 202 takes in source code 114 and parses source code 114 to produce intermediate representation 204.

Intermediate representation 204 feeds into back end 206, which operates on intermediate representation 204 to produce executable code 118. During this process, intermediate representation 204 feeds through optimizer 208, which identifies and marks data references within the code as candidates for prefetching. The output of optimizer 208 into code generator 210, which generates executable code 118. In doing so, code generator 210 inserts prefetch instructions into the code in advance of associated data references.

Process of Inserting Prefetch Instructions

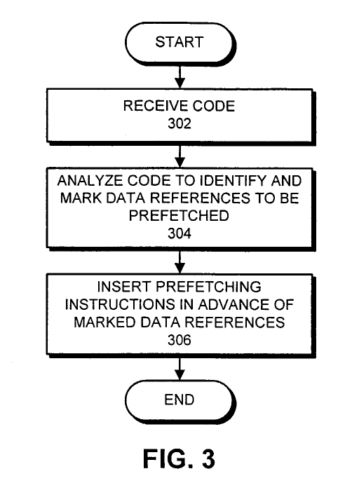

FIG. 3 is a flow chart illustrating the process of inserting prefetch instructions into code in accordance with an embodiment of the present invention. During operation, the system receives source code 114 (step 302), and converts source code into intermediate representation 204. Intermediate representation 204 feeds into optimizer 208, which analyzes intermediate representation 204 to identify and mark references to be prefetched (step 304). Next, code generator 210 inserts prefetch instructions in advance of the marked data references (step 306).

Two-Phase Marking

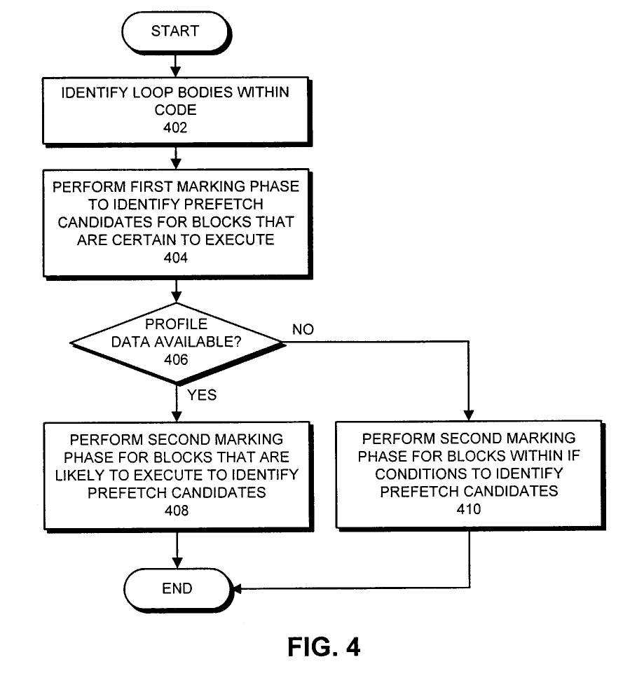

FIG. 4 is a flow chart illustrating the process of performing two-phase marking to identify references for prefetching in accordance with an embodiment of the present invention. Note that the present invention is not meant to be limited to the two-phase marking process described below. In general, a large number of different marking techniques can be used with the present invention.

As is illustrated in FIG. 4, the system starts by identifying loop bodies within the code (step 402). The system then looks for prefetching candidates within the loop bodies, because these loop bodies are executed frequently, and references within these loop bodies are likely to have a predictable pattern. However, note that the present invention is not meant to be limited to systems that consider only references within loop bodies.

In one embodiment of the present invention, if there exists a nested loop the system examines an innermost loop in the nested loop. If the innermost loop is smaller than a minimum size or is executed fewer than a minimum number of iterations, the system examines a loop outside the innermost loop.

In one embodiment of the present invention, the system also determines if there are heavyweight calls within the loop. These heavyweight calls can do a significant amount of work involving movement of data to/from the cache, and can thereby cause prefetching to be ineffective. If such heavyweight calls are detected, the system can decide not to prefetch for the loop. Note that lightweight functions, such as intrinsic function calls are not considered “heavyweight” calls.

In one embodiment of the present invention, the system determines the data size for the loop either at compile time or through profiling information. If this data size is small, there is a high probability that the data for the loop will completely fit within the cache, in which case prefetching is not needed.

The system them performs a two-phase marking process. During a first phase, the system attempts to identify prefetching candidates from basic blocks that are certain to execute (step 404).

Next, during a second phase the system determines if profile data is available for the code (step 406). This profile data indicates how frequently specific basic blocks of the code are likely to be executed.

If profile data is available, the system identifies prefetching candidates from basic blocks that are likely but not certain to execute (step 408). Note that the system can determine if a basic block is likely to execute by comparing a frequency of execution from the execution profile with a threshold value.

If profile data is not available, the system identifies prefetching candidates from basic blocks located within “if” conditions, whether or not the basic blocks are likely to execute (step 410).

For example, consider the exemplary code that appears in Table 1 below.

TABLE 1

| | | |
|---|---|---|
| 1 | for(i=0;i<n;i++) { | |
| 2 | w= a[i] | [symbol] PREFECTH |
| 3 | if(condition) { | |
| 4 | x=a[i]; | [symbol] COVERED |
| 5 | y=a[i−1]; | [symbol] COVERED |
| 6 | z=a[i+1]; | [symbol] PREFETCH |
| 7 | } | |
| 8 | } | |

Table 1 illustrates a “for” loop in the C programming language. During the first phase, the system analyzes the basic block containing line 2 “w=a[i]”, because the basic block is certain to execute. During this first phase, the access to a[i] is marked for prefetching.

During the second phase, the system analyzes the basic block including lines 4-6. Note that this basic block only executes if the condition for the preceding “if” statement is TRUE. In one embodiment of the present invention, this basic block is analyzed if an execution profile indicates that it is likely to execute.

If this basic block is analyzed, the reference to a[i] in line 4 is marked as covered because a[i] is retrieved in the preceding loop iteration by the statement in line 6 which references a[i+1]. Similarly, the reference to a[i−1] is marked as covered because a[i−1] is retrieved in a preceding loop iteration by the statement in line 6 which references a[i+1].

Note that if a one-phase marking process is used in which all basic blocks are considered regardless of if they are certain to execute, the statement at line 2 is marked as covered by the statement at line 6, and no prefetch is generated for the reference to a[i] in line 2. This is a problem if the basic block containing lines 4-6 is not executed, because no prefetch is generated for the reference to a[i] in line 2.

Indexed Array References

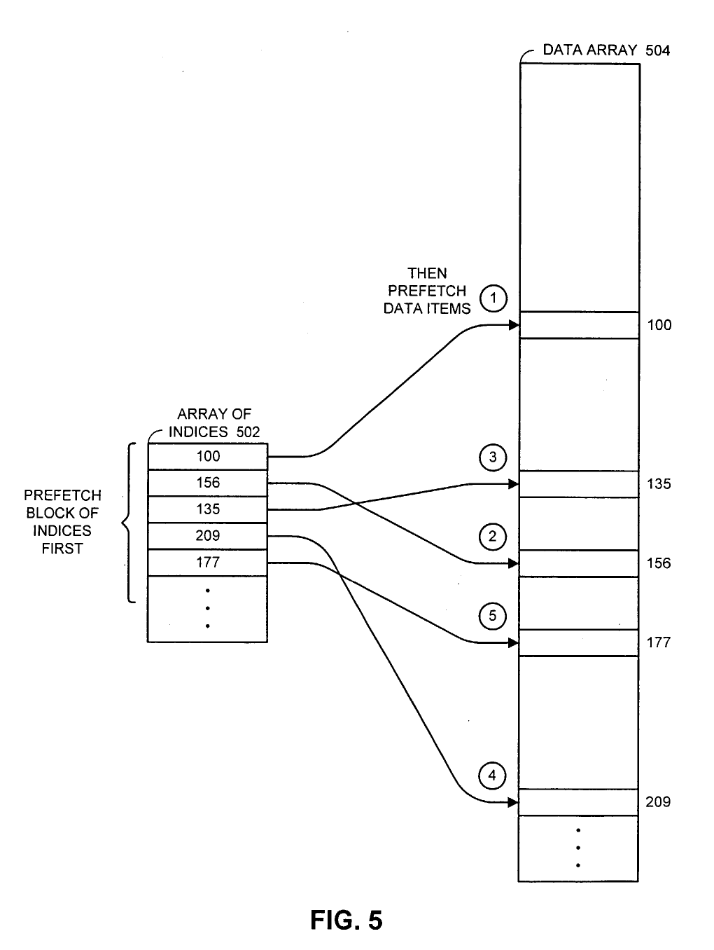

FIG. 5 illustrates how a data array 504 is accessed through an array of indices 502 in accordance with an embodiment of the present invention. As is illustrated in FIG. 5, array of indices 502 contains a list of indices (or pointers) into data array 504. Note that these indices are not in order. This means that if a program linearly scans through array of indices 502 accessing corresponding items in data array 504, the resulting accesses to data array 504 will be irregular. In particular, the string of indices 100, 156, 135, 209 and 177 in array of indices 502, will cause sequential accesses to corresponding locations 100, 156, 135, 209 and 177 in data array 504.

In order to prefetch these data items, one embodiment of the present invention first prefetches a block of indices from array of indices 502. Next, after the block of indices has been prefetched, the system prefetches data items pointed to by these indices from data array 504. The process of generating these prefetch operations is described in more detail below with reference to FIG. 5.

Code Generator

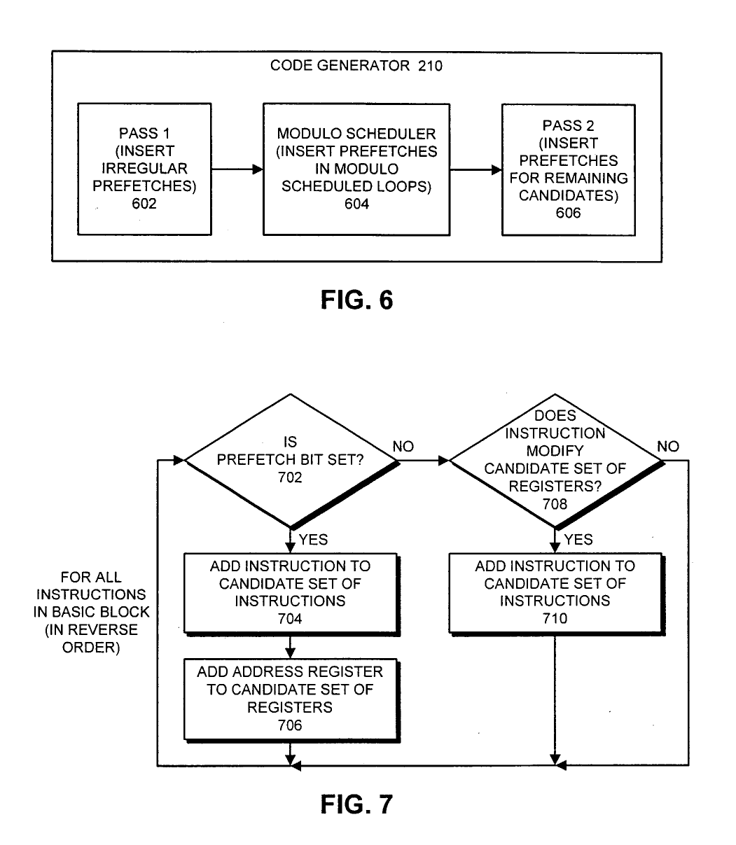

FIG. 6 illustrates how prefetches are inserted by code generator 210 (from FIG. 2) in accordance with an embodiment of the present invention. Code generator 210 performs a number of passes. During pass 1 602, code generator 210 inserts prefetches for irregular memory references, such as indexed array references. Next, modulo scheduler 604 within code generator 210 inserts prefetches for regular memory references that are amenable to modulo scheduling. Finally, during pass 2 606, code generator 210 inserts prefetches for remaining candidate references that could not be prefetched by the modulo scheduler. For example, the remaining candidate references might be associated with memory references within if-then-else constructs in loops.

Determining Candidate Set for Prefetching

FIG. 7 presents a flow chart illustrating how code generator 210 determines which instructions belong to the candidate set for prefetching in accordance with an embodiment of the present invention. During pass 1 602, code generator 210 examines each basic block in the program. In doing so, code generator 210 scans through instructions in each basic block in reverse order.

For each instruction, the system first determines if the prefetch bit is set (step 702). If so, the system adds the instruction to a candidate set of instructions maintained by the system (step 704). The system also adds an address register associated with the instruction to a candidate set of registers maintained by the system (step 706). The system then returns to step 702 to process the next preceding instruction in the basic block.

If at step 702, the prefetch bit for instruction is not set, the system determines if the instruction modifies a register in the candidate set of registers maintained by the system (step 708). If so, the system adds the instruction to a candidate set of instructions (step 710). The system then returns to step 702 to process the next preceding instruction in the basic block.

Prefetches for Indexed Array References

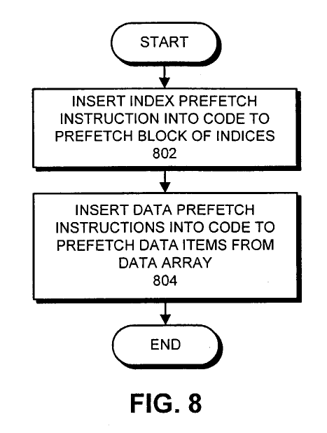

FIG. 8 presents a flow chart illustrating how prefetches are inserted for indexed array references in accordance with an embodiment of the present invention. The system first inserts an index prefetch instruction to prefetch the next block of indices from array of indices 502 (step 802). Next, the system inserts data prefetch instructions into the code to prefetch data items from data array 504 (step 804).

Note that the system inserts the index prefetch instruction sufficiently in advance of the data prefetch instructions, so that the block of indices can be prefetched before the data prefetch instructions are executed. Furthermore, the data prefetch instructions are inserted sufficiently in advance of instructions that use the data items, so that the data items can be prefetched before the data items are used.

In one embodiment of the present invention, the system prefetches future index array references at each iteration of the loop. One criterion we can use for determining whether an index array reference is a prefetch candidate is if the array of indices is not modified within the loop.

Our approach for calculating the “prefetch ahead value” for the data array references is slightly different than for the index array references. It is desirable for the calculation of the optimal prefetch ahead value to satisfy the following two conditions. (1) The prefetch ahead value should be a multiple of the stride of the index array references. (2) The prefetch ahead value should be large enough to allow sufficient cycle distance from the issue of the prefetch to the use of the prefetched data to hide the latency of the prefetch instruction.

Considering the above conditions the prefetch ahead value can be given by the formula

prefetch_ahead_value=stride*prefetch_ahead_distance.

In this formula, the prefetch ahead distance is computed according to the equation

prefetch_ahead_distance=min(covered_latency, prefetch_queue_utilization),

and the prefetch_queue_utilazation value is computed according to the equation

prefetch_queue_utilazation=outstanding_prefetches/prefetch_instructions,

wherein outstanding_prefetches is the number of prefetch instructions held in the prefetch queue of the processor. Additional prefetches are dropped if the prefetch queue is full. Prefetch_instructions is the number of prefetch instructions which will be emitted in the loop.

The covered_latency value for the indexed array references is given by the equation

covered_latency=prefetch_latency/exec_time_single_iter.

After calculating the prefetch ahead value we can prefetch the data(index(i+prefetch_ahead_value)) indexed array reference. In order to prefetch the above reference a non-faulting load, which does not raise an exception in the case of an invalid address, can be introduced to hold the value of index(i+prefetch_ahead_value).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for generating prefetch instructions for indexed array references, comprising:
receiving code to be executed on a computer system;
analyzing the code to identify candidate references to be prefetched, wherein the candidate references can include indexed array references that access a data array through an array of indices; and
inserting prefetch instructions into the code in advance of the identified candidate references;
wherein if the identified candidate references include indexed array references, inserting the prefetch instructions involves,
inserting an index prefetch instruction into the code, which prefetches a block of indices from the array of indices, and
inserting data prefetch instructions into the code, which prefetch data items in the data array pointed to by the block of indices.

2. The method of claim 1,
wherein inserting the index prefetch instruction involves inserting the index prefetch instruction sufficiently in advance of the data prefetch instructions, so that the block of indices can be prefetched before the data prefetch instructions are executed; and
wherein inserting the data prefetch instructions involves inserting the data prefetch instructions sufficiently in advance of instructions that use the data items, so that the data items can be prefetched before the data items are used by the code.

3. The method of claim 1, wherein inserting the index prefetch instruction into the code involves:
obtaining a stride value for the array of indices;
calculating a prefetch ahead distance as a function of a covered latency and a prefetch queue utilization;
wherein the covered latency is calculated by dividing a latency for a prefetch operation by an execution time for a single loop iteration;
wherein the prefetch queue utilization is calculated by dividing a maximum number of outstanding prefetch operations for the computer system by a number of prefetch instructions emitted within a loop body; and
calculating a prefetch ahead value for the index prefetch instruction by multiplying the stride value by the prefetch ahead distance.

4. The method of claim 1, wherein the prefetch instructions are associated with non-faulting load operations that do not raise an exception for an invalid address.

5. The method of claim 1, wherein analyzing the code to identify candidate references to be prefetched involves:
identifying loop bodies within the code; and
identifying candidate references to be prefetched from within the loop bodies.

6. The method of claim 5, wherein analyzing the code to identify candidate references to be prefetched involves examining a pattern of data references over multiple loop iterations.

7. The method of claim 1, wherein indexed array references are identified as candidate references only if an associated array of indices is not modified within a loop body.

8. The method of claim 1, wherein inserting prefetch instructions into the code involves:
inserting irregular prefetch instructions into the code, including prefetch instructions associated with indexed array references;
inserting regular prefetch instructions into the code, including prefetch instructions inserted into modulo scheduled loops; and
inserting prefetch instructions for remaining candidate references into the code.

9. The method of claim 1, wherein analyzing the code to identify candidate references to be prefetched involves performing reuse analysis on the code to determine which array references are likely to generate cache misses.

10. The method of claim 1, wherein analyzing the code involves analyzing the code within a compiler.

11. A computer-readable storage medium storing instructions that when executed by a computer cause the computer to perform a method for generating prefetch instructions for indexed array references, the method comprising:
receiving code to be executed on a computer system;
analyzing the code to identify candidate references to be prefetched, wherein the candidate references can include indexed array references that access a data array through an array of indices; and
inserting prefetch instructions into the code in advance of the identified candidate references;
wherein if the identified candidate references include indexed array references, inserting the prefetch instructions involves,
inserting an index prefetch instruction into the code, which prefetches a block of indices from the array of indices, and
inserting data prefetch instructions into the code, which prefetch data items in the data array pointed to by the block of indices.

12. The computer-readable storage medium of claim 11,
wherein inserting the index prefetch instruction involves inserting the index prefetch instruction sufficiently in advance of the data prefetch instructions, so that the block of indices can be prefetched before the data prefetch instructions are executed; and
wherein inserting the data prefetch instructions involves inserting the data prefetch instructions sufficiently in advance of instructions that use the data items, so that the data items can be prefetched before the data items are used by the code.

13. The computer-readable storage medium of claim 11, wherein inserting the index prefetch instruction into the code involves:
obtaining a stride value for the array of indices;
calculating a prefetch ahead distance as a function of a covered latency and a prefetch queue utilization;
wherein the covered latency is calculated by dividing a latency for a prefetch operation by an execution time for a single loop iteration;
wherein the prefetch queue utilization is calculated by dividing a maximum number of outstanding prefetch operations for the computer system by a number of prefetch instructions emitted within a loop body; and
calculating a prefetch ahead value for the index prefetch instruction by multiplying the stride value by the prefetch ahead distance.

14. The computer-readable storage medium of claim 11, wherein the prefetch instructions are associated with non-faulting load operations that do not raise an exception for an invalid address.

15. The computer-readable storage medium of claim 11, wherein analyzing the code to identify candidate references to be prefetched involves:
identifying loop bodies within the code; and
identifying candidate references to be prefetched from within the loop bodies.

16. The computer-readable storage medium of claim 15, wherein analyzing the code to identify candidate references to be prefetched involves examining a pattern of data references over multiple loop iterations.

17. The computer-readable storage medium of claim 11, wherein indexed array references are identified as candidate references only if an associated array of indices is not modified within a loop body.

18. The computer-readable storage medium of claim 11, wherein inserting prefetch instructions into the code involves:
inserting irregular prefetch instructions into the code, including prefetch instructions associated with indexed array references;
inserting regular prefetch instructions into the code, including prefetch instructions inserted into modulo scheduled loops; and
inserting prefetch instructions for remaining candidate references into the code.

19. The computer-readable storage medium of claim 11, wherein analyzing the code to identify candidate references to be prefetched involves performing reuse analysis on the code to determine which array references are likely to generate cache misses.

20. The computer-readable storage medium of claim 11, wherein analyzing the code involves analyzing the code within a compiler.

21. An apparatus that generates prefetch instructions for indexed array references, comprising:
a receiving mechanism configured to receive code to be executed on a computer system;
an identification mechanism configured to identify candidate references in the code to be prefetched, wherein the candidate references can include indexed array references that access a data array through an array of indices; and
an insertion mechanism configured to insert prefetch instructions into the code in advance of the identified candidate references;
wherein if the identified candidate references include indexed array references, the insertion mechanism is configured to,
insert an index prefetch instruction into the code, which prefetches a block of indices from the array of indices, and to
insert data prefetch instructions into the code, which prefetch data items in the data array pointed to by the block of indices.

22. The apparatus of claim 21,
wherein the insertion mechanism is configured to insert the index prefetch instruction sufficiently in advance of the data prefetch instructions, so that the block of indices can be prefetched before the data prefetch instructions are executed; and
wherein the insertion mechanism is configured to insert the data prefetch instructions sufficiently in advance of instructions that use the data items, so that the data items can be prefetched before the data items are used by the code.

23. The apparatus of claim 21, wherein while inserting the index prefetch instruction, the insertion mechanism is configured to:
obtain a stride value for the array of indices;
calculate a prefetch ahead distance as a function of a covered latency and a prefetch queue utilization;
wherein the covered latency is calculated by dividing a latency for a prefetch operation by an execution time for a single loop iteration;
wherein the prefetch queue utilization is calculated by dividing a maximum number of outstanding prefetch operations for the computer system by a number of prefetch instructions emitted within a loop body; and to
calculate a prefetch ahead value for the index prefetch operation by multiplying the stride value by the prefetch ahead distance.

24. The apparatus of claim 21, wherein the prefetch instructions are associated with non-faulting load operations that do not raise an exception for an invalid address.

25. The apparatus of claim 21, wherein the identification mechanism is configured to:
identify loop bodies within the code; and to
identify candidate references to be prefetched from within the loop bodies.

26. The apparatus of claim 25, wherein the identification mechanism is configured to examine a pattern of data references over multiple loop iterations.

27. The apparatus of claim 21, wherein the identification mechanism is configured to identify indexed array references only if an associated array of indices is not modified within a loop body.

28. The apparatus of claim 21, wherein the insertion mechanism is configured to:
insert irregular prefetch instructions into the code, including prefetch instructions associated with indexed array references;
insert regular prefetch instructions into the code, including prefetch instructions inserted into modulo scheduled loops; and to
insert prefetch instructions for remaining candidate references into the code.

29. The apparatus of claim 21, wherein the identification mechanism is configured to perform reuse analysis on the code to determine which array references are likely to generate cache misses.

30. The apparatus of claim 21, wherein the apparatus is part of a compiler.
